(19) United States
(12) Patent Application Publication
(10) Pub. No.: US 2021/0360351 A1
(43) Pub. Date: Nov. 18, 2021

(54) ANTENNA LINE FOR AUDIO AND BLUETOOTH SIGNALS

(71) Applicant: Innovation Sound Technology Co., Ltd., Shenzhen, Guangdong (CN)

(72) Inventors: Shun Ming Yuen, Shenzhen, Guangdong (CN); Wai Yin Mung, Shenzhen, Guangdong (CN); Ka Ming Wu, Shenzhen, Guangdong (CN)

(21) Appl. No.: 16/469,637

(22) PCT Filed: Feb. 15, 2019
(86) PCT No.: PCT/CN2019/075256

§ 371 Date: Jun. 13, 2019

(30) Foreign Application Priority Data
Jan. 23, 2019 (CN) 201920109434.3

(51) Int. Cl. H04R 9/04; H04W 4/80

(52) U.S. Cl. CPC H04R 9/04; H04W 4/80

(57) ABSTRACT

The present invention belongs to the technical field of antennas and discloses an antenna line for audio and Bluetooth signals. By arranging an input radio frequency choke, the role of insulating a wireless signal from being transmitted to an audio line can be performed. By arranging an output radio frequency choke, the role of insulating the wireless signal from being transmitted to a loudspeaker can be performed. A bendable transmission line can be used as an earphone cable. An audio signal transmission line and a Bluetooth signal transmission line are mixed together, which reduces a PCB wiring space and makes PCB design simpler and smaller. When the audio signal is transmitted to a Bluetooth antenna or another set of wireless signals, the impedance value is very large, so the audio signal could not reach there and will go from an audio signal input port to the loudspeaker without loss.

### TECHNICAL FIELD

The present invention specifically relates to an antenna line for audio and Bluetooth signals, and belongs to the technical field of antennas.

### BACKGROUND

The traditional earphone loudspeaker audio signal line and a Bluetooth signal transmission line are mutually independent (see FIG. 1). An input end of a Bluetooth signal input port is connected with an input end of a band pass filter. An output end of the band pass filter is connected with a Bluetooth antenna through the Bluetooth signal transmission line. An input end of an audio signal input port is connected with a loudspeaker through an audio signal transmission line. Therefore, during use, the audio signal line is far away from the Bluetooth signal transmission line, so as to avoid affecting the characteristic impedance of the transmission line or affecting the audio signal. However, this connection structure takes up a certain space in PCB design. If the PCB design is not good, the audio and Bluetooth signals will affect each other and affect the use of users.

### SUMMARY

The technical problem to be solved by the present invention is to overcome the existing defects, to provide an antenna line for audio and Bluetooth signals. By arranging an input radio frequency choke, the role of insulating a wireless signal from being transmitted to an audio line can be performed. By arranging an output radio frequency choke, the role of insulating the wireless signal from being transmitted to a loudspeaker can be performed. The loudspeaker is composed of coils. A bendable transmission line can be used as an earphone cable. An audio signal transmission line and a Bluetooth signal transmission line are mixed together, which reduces a PCB wiring space and makes PCB design simpler and smaller. When the audio signal is transmitted to a Bluetooth antenna or another set of wireless signals, an impedance value is very large, so that the audio signal will not reach there and the audio signal will go from an audio signal input port to the loudspeaker without loss. The present invention can effectively solve the problems in the background.

To solve the above technical problems, the present invention provides the following technical solution:

The present invention provides an antenna line for audio and Bluetooth signals, comprising a band pass filter, an audio signal transmission line, a Bluetooth signal transmission line, a Bluetooth antenna, a loudspeaker, an output radio frequency choke, an input radio frequency choke, a Bluetooth signal input port, an audio signal input port and a transmission line. An output end of the Bluetooth signal input port is electrically connected with an input end of the transmission line, and one end of the transmission line close to the Bluetooth signal input port is provided with the band pass filter; the other end of the transmission line is connected with the Bluetooth antenna; on a circuit between the band pass filter and the Bluetooth antenna, one end close to the band pass filter is provided with an input radio frequency choke; an input end of the input radio frequency choke is connected with the audio signal input port; on a circuit between the band pass filter and the Bluetooth antenna, one end close to the Bluetooth antenna is provided with the output radio frequency choke; and an output end of the output radio frequency choke is connected with the loudspeaker.

As a preferred technical solution of the present invention, the Bluetooth antenna can be used as an input point of a wireless signal.

The present invention achieves the following beneficial effects: by arranging an input radio frequency choke, the role of insulating a wireless signal from being transmitted to an audio line can be performed. By arranging an output radio frequency choke, the role of insulating the wireless signal from being transmitted to a loudspeaker can be performed. The loudspeaker is composed of coils. A bendable transmission line can be used as an earphone cable. An audio signal transmission line and a Bluetooth signal transmission line are mixed together, which reduces a PCB wiring space and makes PCB design simpler and smaller. When the audio signal is transmitted to a Bluetooth antenna or another set of wireless signals, an impedance value is very large, so that the audio signal will not reach there and the audio signal will go from an audio signal input port to the loudspeaker without loss.

### DESCRIPTION OF DRAWINGS

The drawings are used to provide further understanding for the present invention and constitute part of the present invention. The drawings are used to explain the present invention together with the embodiments of the present invention, and do not constitute a limitation to the present invention.

In the drawings:

FIG. 1 is a schematic diagram of a traditional earphone loudspeaker audio signal line and a Bluetooth signal transmission line.

FIG. 2 is a schematic diagram of an integral structure of an antenna for audio and Bluetooth signals in an embodiment of the present invention.

FIG. 3 is a numerical distribution diagram of feedback loss S 11 when one end of a transmission line is connected with a Bluetooth antenna.

Numbers in the figures: 1 band pass filter; 2 audio signal transmission line; 3 Bluetooth signal transmission line; 4 Bluetooth antenna; 5 loudspeaker; 6 output radio frequency choke; 7 input radio frequency choke; 8 Bluetooth signal input port; 9 audio signal input port; and 10 transmission line.

### DETAILED DESCRIPTION

The preferred embodiment of the present invention will be explained below in detail in combination with drawings. It should be understood that the preferred embodiment described below is only used for describing and explaining the present invention, but is not used for limiting the present invention.

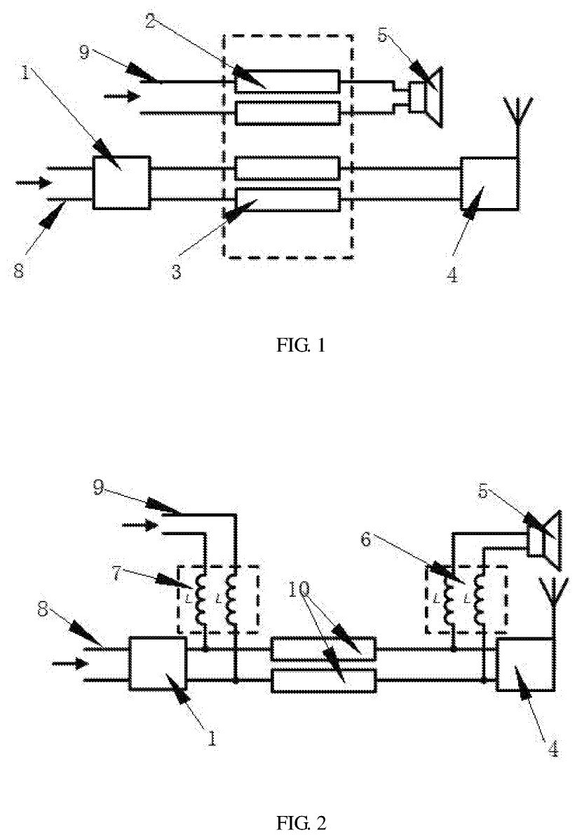

Embodiment: with reference to FIGS. 1-3, an antenna line for audio and Bluetooth signals of the present invention comprises a band pass filter 1, an audio signal transmission line 2, a Bluetooth signal transmission line 3, a Bluetooth antenna 4, a loudspeaker 5, an output radio frequency choke 6, an input radio frequency choke 7, a Bluetooth signal input port 8, an audio signal input port 9 and a transmission line 10. An output end of the Bluetooth signal input port 8 is electrically connected with an input end of the transmission line 10, and one end of the transmission line 10 close to the Bluetooth signal input port 8 is provided with the band pass filter 1; the other end of the transmission line 10 is connected with the Bluetooth antenna 4; on a circuit between the band pass filter 1 and the Bluetooth antenna 4, one end close to the band pass filter 1 is provided with an input radio frequency choke 7; an input end of the input radio frequency choke 7 is connected with the audio signal input port 9; on a circuit between the band pass filter 1 and the Bluetooth antenna 4, one end close to the Bluetooth antenna 4 is provided with the output radio frequency choke 6; and an output end of the output radio frequency choke 6 is connected with the loudspeaker 5. The transmission line 10 may be a bendable transmission line.

Further, the Bluetooth antenna 4 can be used as an input point of a wireless signal.

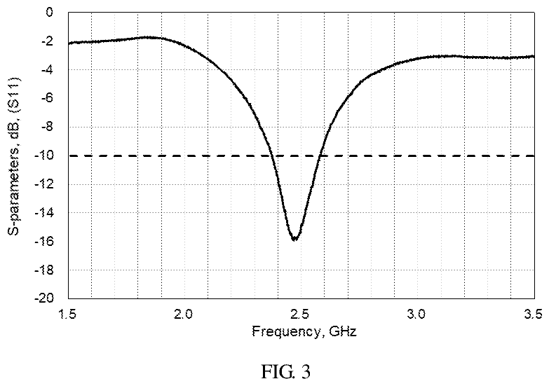

It should be noted that the present invention is an antenna line for audio and Bluetooth signals. During use, in the process of signal input of the Bluetooth signal input port 8, a matching line or a band pass filter can be added, so that the audio signal cannot be transmitted to a wireless line or used for matching. The Bluetooth antenna is a Bluetooth antenna or can be used as an input point of another set of wireless signals. When the audio signal is transmitted to the Bluetooth antenna or another set of wireless signals, the impedance value is very large, so the audio signal will not reach there. For the above reasons, the audio signal is inputted from the audio signal input port 9 to the loudspeaker without loss. FIG. 3 is a distribution diagram of feedback loss S11 when one end of a signal input transmission line of the audio signal input port 9 is connected with the Bluetooth antenna, wherein Bluetooth wireless signals work at frequency from approximately 2.4 GHz to 2.5 GHz.

Finally, it should be noted that the above description is only a preferred embodiment of the present invention, and is not intended to limit the present invention. Although the present invention is described in detail with reference to the above embodiment, those skilled in the art may still modify the technical solution recorded in the above embodiment, or equivalently replace some of the technical features. Any modification, equivalent replacement, improvement, etc. made within the spirit and the principle of the present invention shall be included within the protection scope of the present invention.

What is claimed is:

1. An antenna line for audio and Bluetooth signals, characterized by comprising a Bluetooth signal input port (8), an audio signal input port (9) and a transmission line (10); an output end of the Bluetooth signal input port (8) is electrically connected with an input end of the transmission line (10), and one end of the transmission line (10) close to the Bluetooth signal input port (8) is provided with a band pass filter (1); the other end of the transmission line (10) is connected with a Bluetooth antenna (4); on a circuit between the band pass filter (1) and the Bluetooth antenna (4), one end close to the band pass filter (1) is provided with an input radio frequency choke (7); an input end of the input radio frequency choke (7) is connected with the audio signal input port (9); on a circuit between the band pass filter (1) and the Bluetooth antenna (4), one end close to the Bluetooth antenna (4) is provided with an output radio frequency choke (6); and an output end of the output radio frequency choke (6) is connected with a loudspeaker (5).

2. The antenna line for audio and Bluetooth signals according to claim 1, characterized in that the Bluetooth antenna (4) is used as an input point of a wireless signal.
